(19) United States
(12) Patent Application Publication
(10) Pub. No.: US 2010/0303253 A1
(43) Pub. Date: Dec. 2, 2010

(54) VEHICLE CONTROL DEVICE AND VEHICLE STATE MONITORING METHOD

(75) Inventors: Naoki Sakai, Kobe (JP); Ryuuji Nishimura, Kobe (JP); Kyohhei Morita, Kobe (JP); Kazumasa Kameda, Kobe (JP); Takahiro Koizumi, Kobe (JP); Tomohiko Nukano, Kobe (JP)

Correspondence Address: OLIFF & BERRIDGE, PLC, P.O. BOX 320850, ALEXANDRIA, VA, 22320-4850, US

(73) Assignee: Fujitsu Ten Limited, Kobe-shi (JP)

(21) Appl. No.: 12/734,843

(22) PCT Filed: Nov. 28, 2008
(86) PCT No.: PCT/JP2008/071719

§ 371 Date: May 27, 2010

(30) Foreign Application Priority Data
Dec. 14, 2007 (JP) 2007-324027

(51) Int. Cl. H04B 1/00

(52) U.S. Cl. 381/86

(57) ABSTRACT

A vehicle control device has a plurality of speakers and a security ECU which identifies whether a door is opened or unlocked on the basis of output signals from the speakers. The security ECU identifies the driving direction of a driven portion on the basis of the difference between input times of sounds inputted to the speakers. Moreover, the ECU has RAM containing the waveforms of the signals outputted from the speakers and compares the waveforms of the signals contained in the RAM with the waveforms of the signals outputted from the speakers to identify the driving direction of the driven portion.

### TECHNICAL FIELD

The present invention relates to techniques detecting a state of a vehicle.

### BACKGROUND ART

There has been conventionally known of techniques to detect vibration of a vehicle by using a speaker for a car audio mounted to the vehicle (For example, see Patent References 1 and 2).

A back electromotive force is generated by vibration of a voice coil caused by a vehicle vibration in a speaker device which makes sound by providing output signals of an audio amplifier circuit to the voice coil located in a magnetic field. The vehicle vibration can be detected by detecting the back electromotive force.

[Patent Reference 1] Japanese Patent Application Publication No. 2005-262944

[Patent Reference 2] Japanese Patent Application Publication No. 2007-137157

### DISCLOSURE OF THE INVENTION

### Problems to be Solved by the Invention

In the vehicle, an opened/closed state of a door and a locked state of a door are generally detected by sensors detecting physical contact. However, for preparing to the case of such sensors failure or reducing cost, techniques that makes it possible to recognize a state of a driven part of the vehicle without using sensors detecting physical contact are sought.

The present invention is made in views of above circumstances, and the aim of the present invention is to provide a vehicle control device and a vehicle state monitoring method capable of detecting a state of a driven part of a vehicle without using sensors detecting physical contact.

### Means for Solving the Problems

To achieve the above aims, a vehicle control device includes sound input means; and identification means for identifying a driven direction of a driven part driven to a predetermined direction on the basis of an output signal of the sound input means.

Therefore, it is possible to recognize a state of a driven part by an output signal of the sound input means. This makes it unnecessary to use sensors detecting physical contact.

In the above vehicle control device, it is possible to include a plurality of sound input means, the identification means identifying the driven direction of the driven part on the basis of a difference between input times of sound input to the plurality of sound input means.

Therefore, it is possible to identify the driven direction of the driven part with good accuracy.

In the above vehicle control device, it is possible to include storage means for storing a waveform of a signal output from the sound input means when the driven part is driven, and the identification means may identifies the driven direction of the driven part by a pattern matching between a waveform of a signal output from the sound input means and the waveform of the signal stored in the storage means.

Therefore, it is possible to identify the driven direction of the driven part easily with good accuracy by using an output signal of the sound input means.

In the above vehicle control device, it is possible to include lock/unlock control means for locking/unlocking a door according to an operation of a user, and the identification means may determine whether one of transitions from a locked state of the door to an unlocked state and from a closed state of the door to an opened state without a control of the lock/unlock control means occurs by using the output signal of the sound input means.

Therefore, it is possible to monitor whether the door is unlocked or whether the door is opened on the basis of the output signal output from the sound input means after the door is locked.

In the above vehicle control device, it is possible to include alarm means for outputting an alarm when one of transitions from the locked state of the door to the unlocked state and from the closed state of the door to the opened state without the control of the lock/unlock control means is detected.

Therefore, it is possible to detect the abnormal state of the vehicle and sound an alarm.

In the above vehicle control device, the identification means may identify one of an opened/closed sound of the door and an operated sound of a doorknob on the basis of a signal output from the sound input means, and determine a door opening/closing operation.

In the above vehicle control device, the identification means may identify a driven sound of a door lock motor which makes the door be in the locked state or in the unlocked state on the basis of the signal output from the sound input means, and may determines a door locking operation and a door unlocking operation.

A vehicle state monitoring method of the present invention is characterized by including: a step receiving a sound by using a plurality of sound input means; and a step identifying a driven direction of a driven part on the basis of a difference between input times of sounds input to the plurality of sound input means.

### Effects of the Invention

According to the present invention, it is possible to detect a state of a driven part of a vehicle by using an output signal of a sound input unit.

### BRIEF DESCRIPTION OF DRAWINGS

FIG. 1 is a diagram illustrating a composition of an embodiment in accordance with a vehicle control device;

FIG. 2 is a diagram illustrating locations of speakers mounted to a vehicle;

FIG. 3 is a diagram illustrating a composition of a body ECU;

FIG. 4 is a diagram illustrating a hardware structure of a microcomputer;

FIG. 5A illustrates signal waveforms of back electromotive forces detected by speakers when a door is locked, and FIG. 5B illustrates signal waveforms of back electromotive forces detected by speakers when a door is unlocked;

FIG. 6 is a diagram illustrating a procedure of a security ECU; and

FIG. 7 is a flowchart illustrating a procedure for determining a door opening/closing operation, a door locking operation and a door unlocking operation.

### BEST MODES FOR CARRYING OUT THE INVENTION

A description will now be given, with reference to accompanied drawings, of best embodiment of the present invention.

### Embodiment

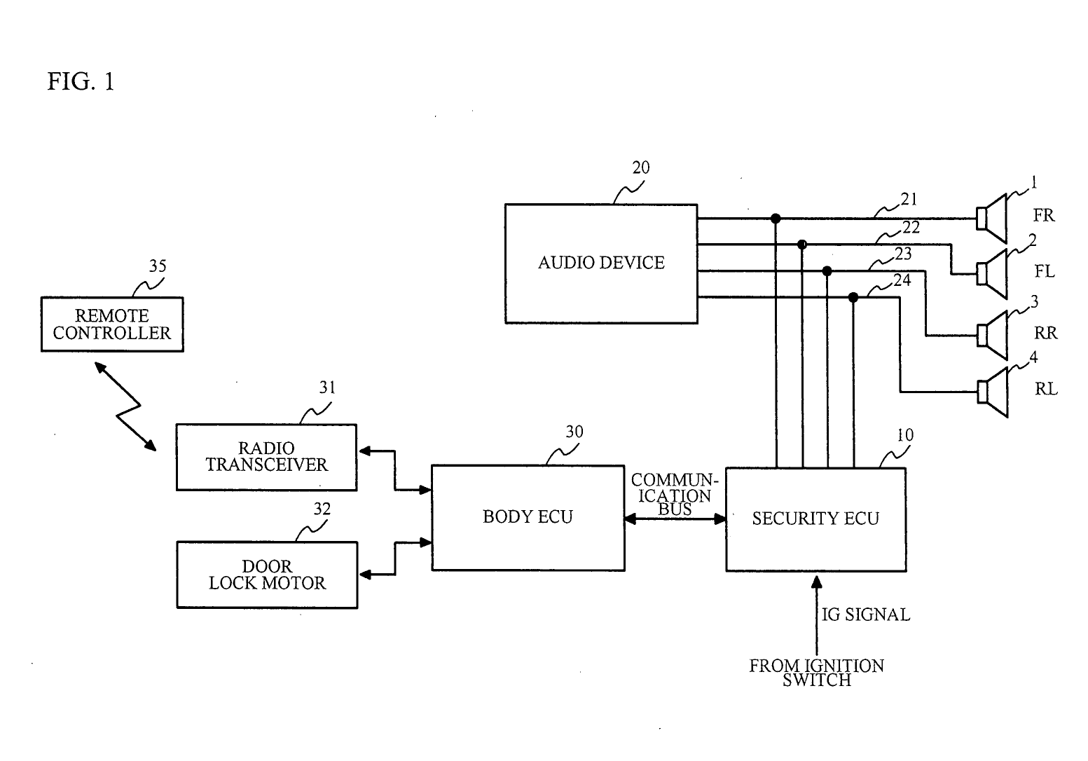

Referring to FIG. 1, a description will be given of a composition of the present embodiment.

As illustrated in FIG. 1, the present embodiment has a composition where a security ECU (Electric Control Unit) 10 is coupled to a signal line which couples an audio device 20 to multiple speakers 1, 2, 3 and 4 that are output units of the audio device. The security ECU 10 functions as a vehicle control device in the present embodiment. The security ECU 10 is coupled to a body ECU 30 by a communication bus, and communicates with the body ECU 30 with a protocol such as CAN (Controller Area Network).

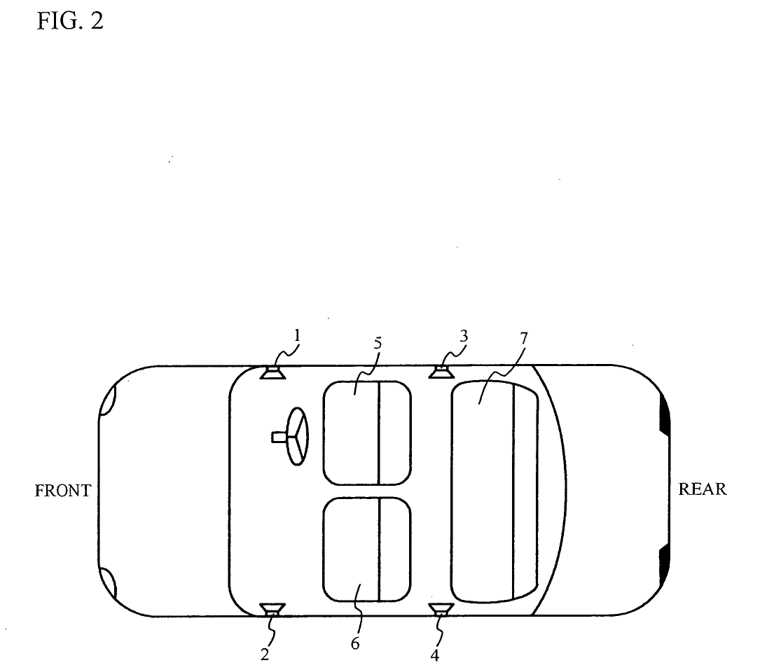

The multiple speakers (sound input units) are located in different places in the vehicle. It is desirable to spread these speakers to back and front and left and right. In the present embodiment, as illustrated in FIG. 2, a front speaker FR1 on a driver's seat 5 side that is located on a door to a driver's seat 5 and faces to a vehicle interior, a front speaker FL2 on the passenger seat 6 side that is located on a door to a passenger's seat 6 and faces to the vehicle interior, a rear speaker RR3 on the driver's seat 5 side that is located on a door to a rear seat 7 and faces to the vehicle interior, and a rear speaker RL4 on the passenger's seat 6 side that is located on a door to the rear seat 7 and faces to the vehicle interior are provided. Hereinafter, the front speaker FR1 on the driver's seat 5 side is referenced as a speaker 1, the front speaker FL2 on the passenger seat 6 side is referenced as a speaker 2, the rear speaker RR3 on the driver's seat 5 side is referenced as a speaker 3, and the rear speaker RL4 on the passenger's seat 6 side is referenced as a speaker 4. Speakers mounted to the vehicle are not limited to these speakers. It is possible to provide a speaker in a front panel part of the vehicle, or a rear side of the rear seat 7, for example.

The audio device 20 processes signals input from multiple audio sources such as a DVD player, a CD player and a tuner, and generates audible signals to be played by speakers, and provide audible signals to speakers 1, 2, 3 and 4.

The body ECU 30 is a control device that performs controls to lock/unlock doors and put power windows up and down.

A radio transceiver 31 is coupled to the body ECU 30. The body ECU 30 communicates with a remote controller 35 via radio waves by using the radio transceiver 31. The remote controller 35 is provided with a door lock control switch. When a user performs a predetermined operation to the door lock control switch of the remote controller 35, the remote controller 35 transmits an indication signal that indicates locking/unlocking of the door via radio communication. This indication signal includes an ID number specific to the remote controller 35. The ID number of the remote controller 35 is stored in a memory of the body ECU 30 (described later). The body ECU 30 determines whether the ID number transmitted from the remote controller 35 via radio communication is the correct one stored in the memory. When the ID number is correct, the body ECU 30 drives a door lock motor 32, and performs a door locking operation or a door unlocking operation. The body ECU 30 outputs a state signal indicating a locked/unlocked state of the door to the security ECU 10. The body ECU 30 functions as lock/unlock control unit.

The security ECU 10 receives a state signal indicating a locked/unlocked state of the door from the body ECU 30, and a signal (hereinafter referenced as an IG signal) indicating whether an ignition key is inserted to a key slot, and whether the ignition switch is in an ON-state from an ignition switch (not illustrated). The security ECU 10 detects an intrusion into a vehicle interior by illegal operations such as an illegal unlocking of the door, on the basis of these signals and output signals of speakers 1, 2, 3 and 4, and sounds the alarm.

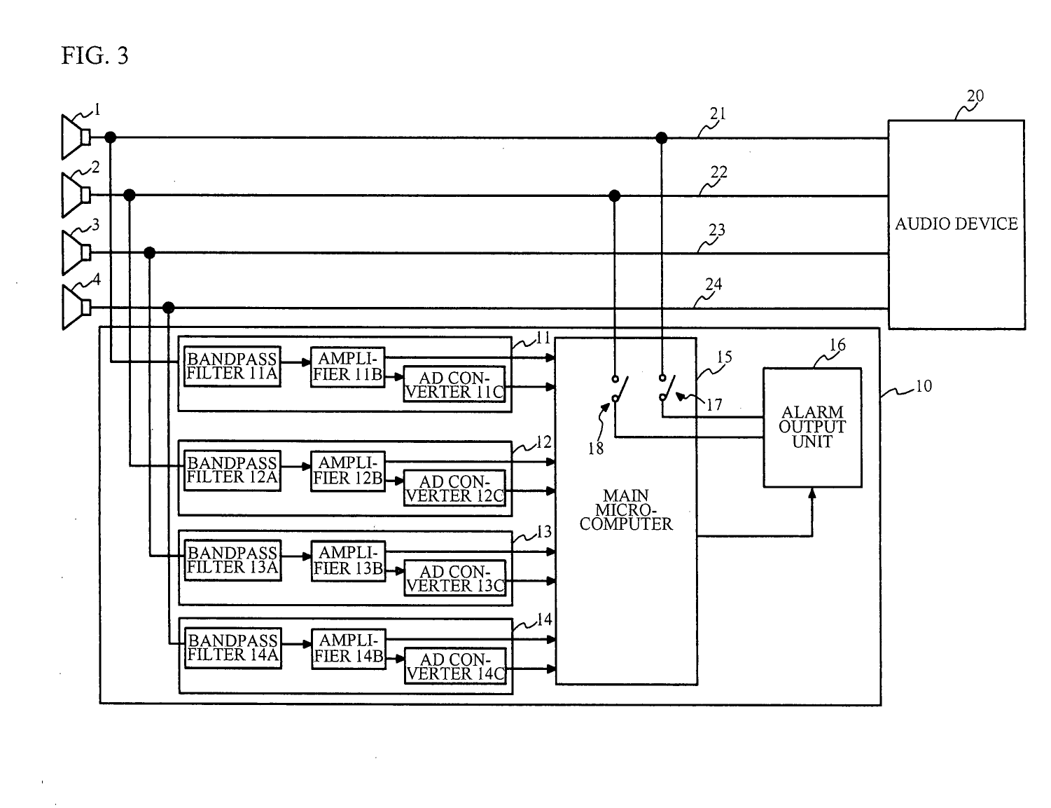

A composition of the security ECU 10 is illustrated in FIG. 3. As illustrated in FIG. 3, the security ECU 10 is provided with signal processing units 11, 12, 13 and 14, a main microcomputer 15 and an alarm output unit 16.

The signal processing units 11, 12, 13 and 14 are respectively provided in accordance with speakers 1, 2, 3 and 4 mounted to the vehicle. The signal processing unit 11 is coupled to a signal line 21 which couples the audio device 20 with the speaker 1, the signal processing unit 12 is coupled to a signal line 22 which couples the audio device 20 to the speaker 2, the signal processing unit 13 is couple to a signal line 23 which couples the audio device 20 with the speaker 3, and the signal processing unit 14 is coupled to a signal line 24 which couples the audio device 20 with the speaker 4. Signal processing units 11, 12, 13 and 14 have a same composition. Therefore, a description will be given of the signal processing unit 11 on behalf of other signal processing units.

The signal processing unit 11 includes a bandpass filter 11A, an amplifier 11B and AD converter 11C, receives a signal of back electromotive force generated in the speaker 1, and executes filtering and amplification. An amplified signal that is AD-converted by the AD converter 11C and an amplified signal that is not AD-converted are output from the signal processing unit 11 to the main microcomputer 15.

The main microcomputer 15 receives signals processed by signal processing units 11, 12, 13 and 14, and detects the door opening/closing operation, the door locking operation, and the door unlocking operation.

When it is determined that the vehicle is in danger of a theft or a car break-in based on the detection result of the opened/closed state of the door or the locked state of the door, a signal is output to the alarm output unit 16, and an alarm sound is output. In the present embodiment, the alarm sound that the alarm output unit 16 generates is output from speakers 1 and 2. When the alarm sound is output, the main microcomputer 15 turns on switches 17 and 18, and connects the alarm output unit 16 and signal lines 21 and 22.

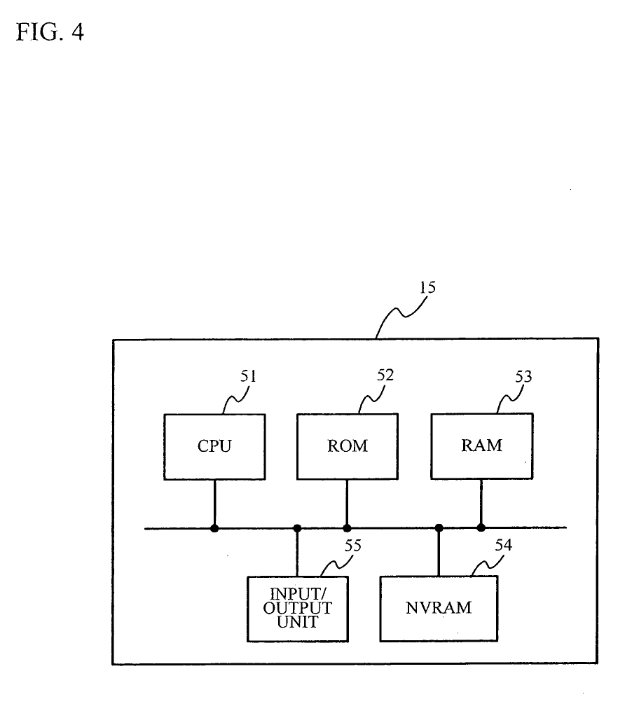

FIG. 4 illustrates a hardware structure of the main microcomputer 15.

The main microcomputer 15 includes a CPU 51, a ROM 52, a RAM 53, an NVRAM (Non Volatile RAM) 54, an input/output unit 55 and the like. The CPU 51 reads programs stored in the ROM 52, and executes calculations according to programs. As programs stored in the ROM 52 are read by the CPU 51, the opened/closed state of the door and the locked state of the door are detected. These determination procedures will be described in detail later with reference to a flowchart. Data such as calculation results are written in the RAM 53. Data that are included in data written in the RAM 53 and are necessary to be stored during power-off are written into the NVRAM 54. The body ECU 30 also includes a main microcomputer which has a composition illustrated in FIG. 4, and controls the opened/closed state of the door and the locked state of the door.

The security ECU 10 uses multiple speakers 1, 2, 3 and 4 mounted in the vehicle as a microphone, and detects the door opening/closing operation, the door locking operation, and the door unlocking operation from signal waveforms of back electromotive forces generated in speakers 1, 2, 3 and 4.

In speakers 1, 2, 3 and 4, back electromotive force is generated by vibration of a voice coil located in magnetic field caused by the vehicle vibration.

Signal waveforms of back electromotive forces generated in speakers 1, 2, 3 and 4 at the time of the door opening/closing operation, the door locking operation, and the door unlocking operation are stored in the RAM 53 of the security ECU 10 as multiple pattern signals. The security ECU 10 performs a pattern matching between a signal waveform of back electromotive force input from at least one of speakers 1, 2, 3 and 4 and a pattern signal stored in the RAM 53, and determines the door opening/closing operation and the door locking/unlocking operation

Feature points of a signal compared in the pattern matching include a signal level, a signal length (a period that a signal of which the level is over a given level is output), and a difference between delay times of signals output from speakers 1, 2, 3 and 4.

It is possible to use an operated sound of a doorknob for the determination of the door opening/closing other than the opened/closed sound of the door. The operated sound of the doorknob is stored in the RAM 53 as the pattern signal, and the door opening/closing operation is determined by the pattern matching with signals output from speakers.

For example, assume that the door of the driver's seat 5 is opened and closed. In this case, the level of signal output from the speaker 1 which is located on the door of the driver's seat 5 is greatest, and there is a difference of over predetermined value from levels of signals output from other speakers 2, 3 and 4.

As the opened/closed sound of the door is curried in the air, and input to speakers 1, 2, 3 and 4, the signal of the back electromotive force generated in the speaker 1 which is nearest to the opened/closed door is fastest output, and the signal of the back electromotive force generated in the speaker which is farthest from the opened/closed door is last output. The difference between arrivals times of the opened/closed sound of the door at speakers shows up as the difference between generated times of back electromotive forces in speakers.

It is possible to determine whether the signal is a signal at the time of the door opening/closing operation or the door locking/unlocking operation by comparing the signal length (the period that the signal level is greater than or equal to the given value) to the pattern signal stored in the RAM 53.

For example, as the doorknob is operated during the door opening/closing operation, it is possible to determine the door opening/closing operation by detecting this sound by speakers 1, 2, 3 and 4 and comparing it to the pattern signal. The driven sound of the door lock motor is generated when the door is locked/unlocked. It is possible to determine the door locking operation and the door unlocking operation by detecting this sound by speakers 1, 2, 3 and 4 and comparing it to the pattern signal.

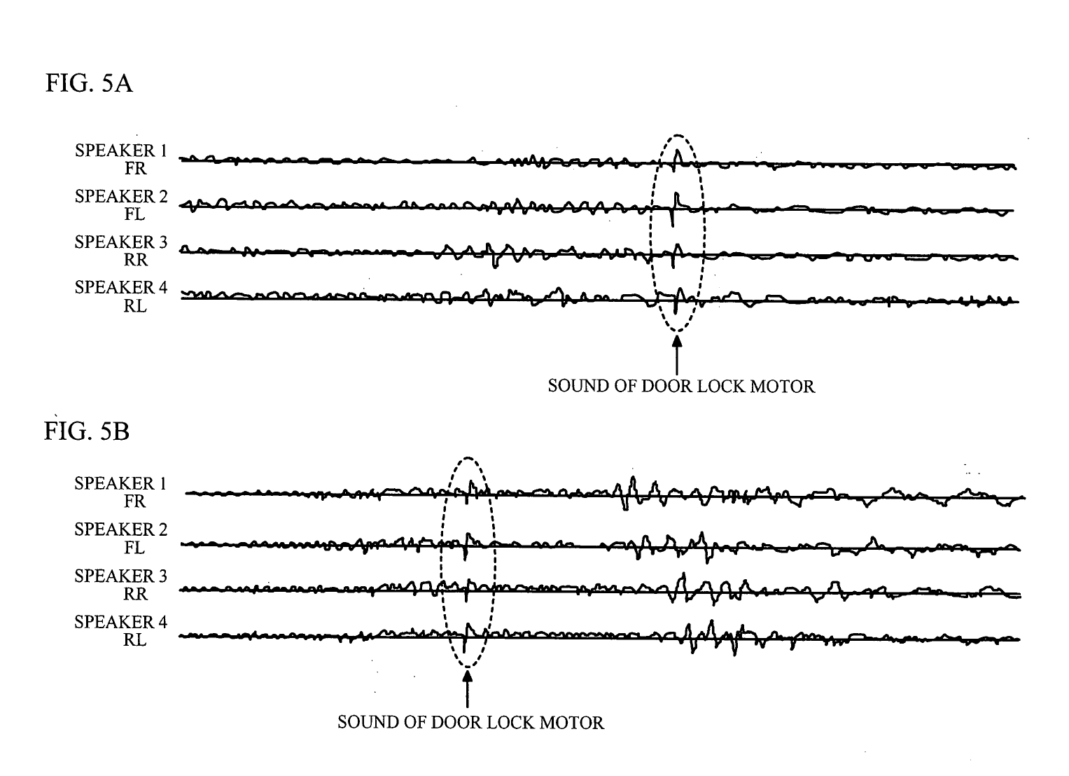

FIG. 5A illustrates waveforms of signals detected by speakers 1, 2, 3 and 4 when the door is locked. The region indicated with the dashed line in FIG. 5A illustrates the driven sound when the door lock motor is driven. FIG. 5B illustrates waveforms of signals detected by speakers 1, 2, 3 and 4 when the door is unlocked. In the same manner, the region indicated with the dashed line in FIG. 5B illustrates the driven sound when the door lock motor 32 is driven.

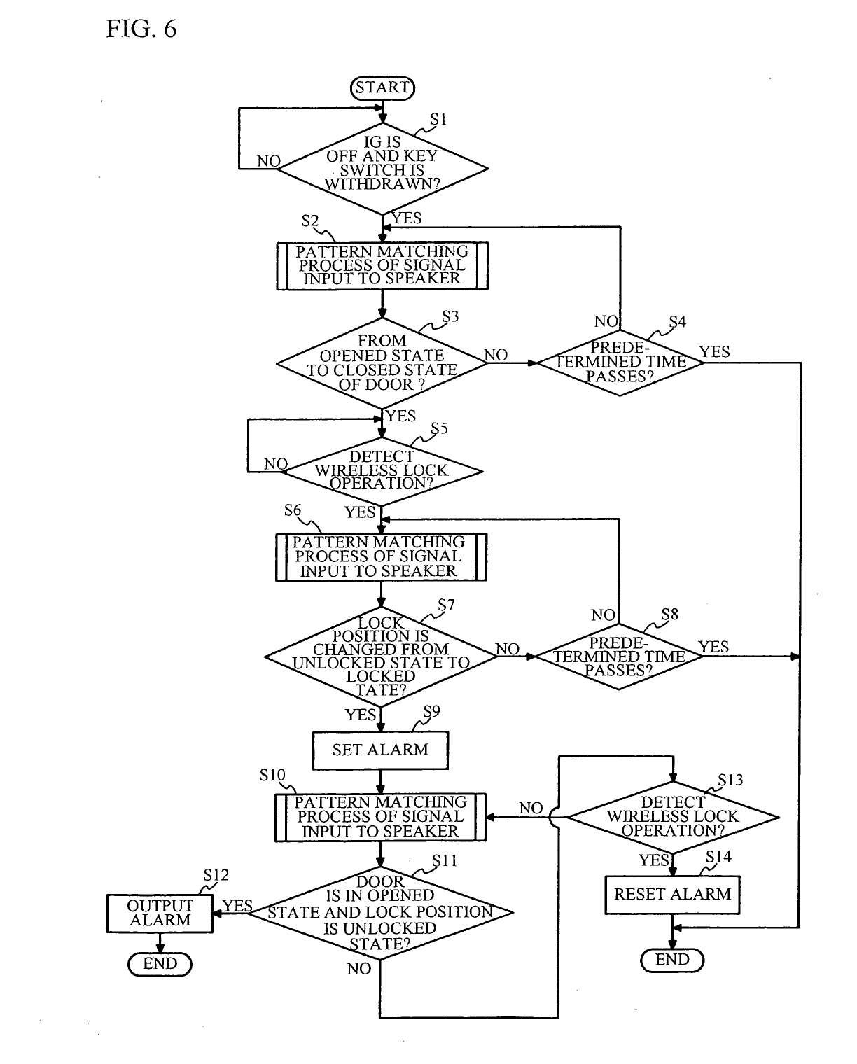

Referring to FIG. 6, a processing procedure of the security ECU 10 will be described.

The security ECU 10 receives a signal indicating whether an ignition switch is turned OFF and an ignition key is withdrawn from a key slot, from the ignition switch (not illustrated).

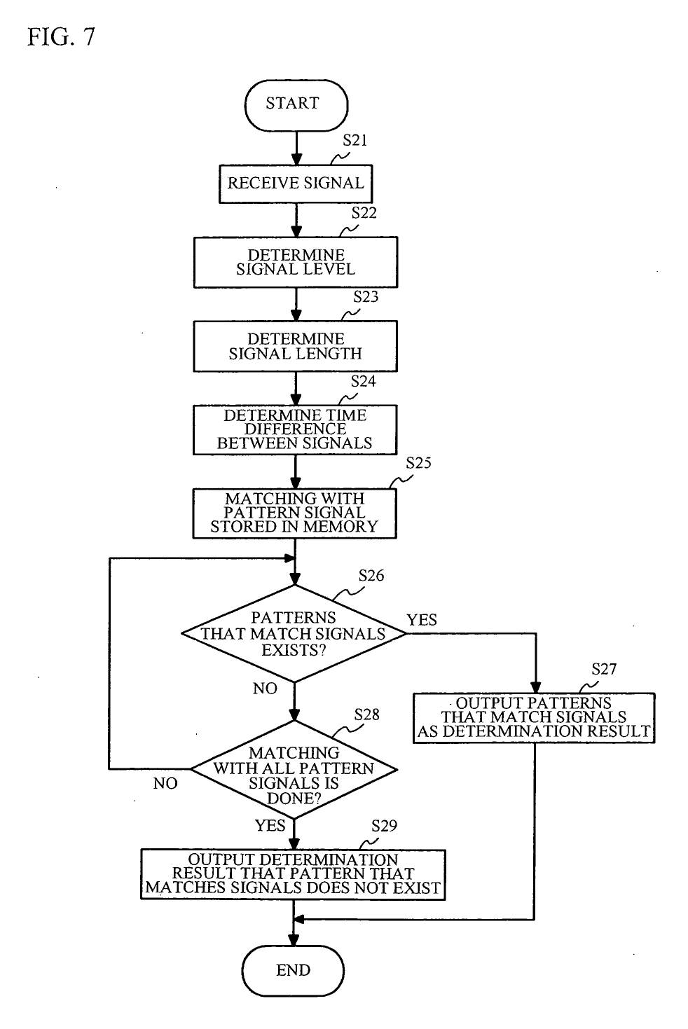

When it is determined that the ignition switch is turned OFF and the ignition key is withdrawn from the key slot (step S1/YES), the security ECU 10 executes the pattern matching process between output signals from speakers 1, 2, 3 and 4 and pattern signals stored in the RAM 53 (step S2), and determines whether the state is changed from the state that the door is opened to the state that the door is closed (step S3). The processing procedure of the pattern matching using signals output from speakers 1, 2, 3 and 4 will be described later with reference to a flowchart illustrated in FIG. 7. When the change from the opened state of the door to the closed state of the door is not detected over the predetermined time (steps S3/NO and S4/YES), this process is ended.

When it is determined that the state is changed from the opened state of the door to the closed state of the door as a result of the pattern matching process (step S3/YES), the security ECU 10 determines whether the wireless lock operation is performed by the remote controller 35 (step S5).

The security ECU 10 receives the state signal indicating the locked/unlocked state of the door from the body ECU 30, and determines whether the door locking operation is performed or not.

When the wireless lock operation is detected based on the signal from the body ECU 30 (step S5/YES), the security ECU 10 executes the pattern matching process between output signals from speakers 1, 2, 3 and 4 and pattern signals stored in the RAM 53 (step S6), and determines whether the locking operation is performed on the door lock (step S7). The detail of the pattern matching process will be described later with reference to the flowchart illustrated in FIG. 7.

When it is determined that the locking operation is performed on the door as a result of the pattern matching process (step S7/YES), the security ECU 10 sets the alarm (step S9), and sets the alarm output unit 16 to output the alarm when the abnormality is detected. When the door locking operation is not detected over predetermined time (steps S7/NO and S8/YES), this process is ended.

Then, the security ECU 10 executes the pattern matching process between output signals from speakers 1, 2, 3 and 4 and pattern signals stored in the RAM 53 (step S10), and determines whether the locked state of the door becomes the unlocked state and the door is in the opened state without the wireless lock operation (step S11). It is determined whether the door is unlocked by the illegal operation by the car break-in or the theft, and is in the opened state. When it is detected that the door is unlocked and is in the opened state (step S11/YES), the security ECU 10 turns on switches 17 and 18, and outputs the alarm sound from the alarm output unit 16 from speakers 1 and 2 (step S12).

When the door unlocking operation or the door opening operation are not detected (step S11/NO), the security ECU 10 determines whether the door is unlocked by the wireless lock operation (step S13). When it is determined that the door is unlocked by the wireless lock operation based on the signal from the body ECU 30 (step S13/YES), the security ECU 10 releases the alarm setting and ends the process (step S14). When the unlocking of the door by the wireless lock operation is not detected (step S13/NO), the security ECU 10 executes the pattern matching process between output signals from speakers 1, 2, 3 and 4 and pattern signals stored in the RAM 53, and continues monitoring the door opening/closing operation and the door locking operation (step S11).

In the flowchart illustrated in FIG. 6, the alarm is output from the alarm output unit 16 when the locked state of the door becomes the unlocked state and the door is opened in the step S11, but it is possible to output the alarm when the locked state of the door becomes the unlocked state, or when the door goes into the opened state.

Referring to a flowchart illustrated in FIG. 7, the pattern matching process will be described. The security ECU 10 receives signals output from speakers 1, 2, 3 and 4 (step S21), and judges signal levels of these signals (step S22). Then, the security ECU 10 determines lengths of signals (the period that the signal level is greater than or equal to the given value) output from speakers 1, 2, 3 and 4 (step S23). The security ECU 10 determines differences between delay times of signals output from speakers 1, 2, 3 and 4 (step S23). When the security ECU 10 obtains these information, it compares the signal levels, signal lengths and time differences between signals of pattern signals stored in the RAM 53 to the signal levels, signal lengths, and time differences between signals of output signals from speakers 1, 2, 3 and 4 (step S25).

When pattern signals that match output signals from speakers 1, 2, 3 and 4 are detected (step S26/YES), the security ECU 10 outputs patterns that match output signals as the determination result (step S27). When pattern signals that match output signals are not detected even though the pattern matching using all pattern signals stored in the RAM 53 is executed (steps S26/NO and S28/YES), the security ECU 10 outputs the determination result that the pattern signal that matches output signals does not exist (step S29).

In the above embodiment, it is determined whether the door opening/closing operation and the door locking operation by the illegal operation are performed when the door is locked. It may be possible to detect the opening/closing of the door when the door is not locked. For example, the door opening operation while the user of the vehicle does not lock the door and is away from the vehicle is detected. When the ignition key is not inserted to the key slot over the predetermined period after the door opening operation is detected, it is determined that there is a danger of the theft, and the alarm is output.

In the above processing procedure illustrated in the flowchart, all output signals from speakers 1, 2, 3 and 4 are used for detecting the door opening operation, or the door locking operation, but the output signal from the speaker used to detect the operation may be more than one.

As described above, in the present embodiment, it is possible to detect the opened/closed state of the door and the locked state of the door based on output signals from speakers 1, 2, 3 and 4. Therefore, even though failures occur in the sensor detecting the opened/closed state of the door and the locked state of the door, it is possible to detect the opened/closed state of the door and the locked state of the door.

It becomes unnecessary to provide a sensor detecting the opened/closed state of the door and the locked state of the door in the vehicle, and it is possible to reduce cost.

As it is unnecessary for the security ECU to communicate with the body ECU and obtains signals indicating the opened/closed state of the door and the locked state of the door, it is possible to reduce the number of harnesses equipped in the vehicle.

Although detail descriptions are given of a preferred embodiment of the present invention, the present invention is not limited to the specifically described embodiment and variation, but other embodiments and variations may be made without departing from the scope of the present invention.

For example, in the above embodiment, the locking/unlocking of the door is performed by the operation of the door lock control switch of the remote controller 35, but it may be possible to provide the door lock control switch outside of the vehicle body, and to perform the normal locking/unlocking of the door by the body ECU 30 in response to the operation of the door lock control switch outside of the vehicle body meeting a given condition (e.g. the condition that the smart key is detected). The operation of the remote controller 35 or the door lock control switch provided to the vehicle body can be said to be a normal operation of the user.

In the above embodiment, the speaker for audio is used as a sound input unit, but it is possible to provide a dedicated microphone.

1. A vehicle control device comprising:
a sound input unit; and
an identification unit that identifies a driven direction of a driven part driven to a predetermined direction on the basis of an output signal of the sound input means.

2. The vehicle control device according to claim 1, further comprising a plurality of sound input means, the identification means identifying the driven direction of the driven part on the basis of a difference between input times of sound input to the plurality of sound input means.

3. The vehicle control device according to claim 1, further comprising a storage unit that stores a waveform of a signal output from the sound input means when the driven part is driven, the identification unit identifying the driven direction of the driven part by a pattern matching between a waveform of a signal output from the sound input unit and the waveform of the signal stored in the storage unit.

4. The vehicle control device according to claim 1, further comprising a lock/unlock control unit that locks/unlocks a door according to an operation of a user, the identification unit determining whether one of transitions from a locked state of the door to an unlocked state and from a closed state of the door to an opened state without a control of the lock/unlock control unit occurs by using the output signal of the sound input unit.

5. The vehicle control device according to claim 4, further comprising an alarm unit that outputs an alarm when one of transitions from the locked state of the door to the unlocked state and from the closed state of the door to the opened state without the control of the lock/unlock control unit is detected.

6. The vehicle control device according to claim 1, wherein the identification unit identifies one of an opened/closed sound of the door and an operated sound of a doorknob on the basis of a signal output from the sound input means, and determines a door opening/closing operation.

7. The vehicle control device according to claim 1, wherein the identification unit identifies a driven sound of a door lock motor which makes the door be in the locked state or in the unlocked state on the basis of the signal output from the sound input means, and determines a door locking operation and a door unlocking operation.

8. A vehicle state monitoring method comprising:
a step receiving a sound by using a plurality of sound input units; and
a step identifying a driven direction of a driven part on the basis of a difference between input times of sound input to the plurality of sound input units.
